(19) United States
(12) Patent Application Publication
(10) Pub. No.: US 2002/0130249 A1
(43) Pub. Date: Sep. 19, 2002

(54) Optical subassembly

(76) Inventor: James F. Dormer, Limekiln, PA (US)

Correspondence Address: JONES VOLENTINE, P.L.L.C., SUITE 150, 12200 SUNRISE VALLEY DRIVE, RESTON, VA, 20191, US

(21) Appl. No.: 09/943,082

(22) Filed: Aug. 31, 2001

Related U.S. Application Data
(60) Provisional application No. 60/276,130, filed on Mar. 16, 2001.

(51) Int. Cl. H01J 3/14; H01J 5/16

(52) U.S. Cl. 250/216

(57) ABSTRACT

An optical subassembly includes two active optical elements on the same submount mounted at an angle to one another to provide optical coupling between them. The submount may include a portion bent upward in a principal plane thereof to provide the angle. The submount may serve as a heat sink. The active optical elements on the submount may be directly electrically connected to a circuit board on which the submount is provided.

### CROSS REFERENCE TO RELATED APPLICATIONS

The present application claims priority under 35 U.S.C. §119(e) to U.S. Provisional Application No. 60/276,130 entitled “Optical Subassembly” filed Mar. 16, 2001, which is hereby incorporated by reference in its entirety for all purposes.

### FIELD OF THE INVENTION

The present invention relates generally to an optical subassembly, and specifically to an optical subassembly, and method of manufacture, having an active transmitting optical device and an active detecting device collocated on a single submount.

### BACKGROUND OF THE INVENTION

The increasing demand for high-speed voice and data communications has led to an increased reliance on optical communications, especially optical fiber communications. The use of optical signals as a vehicle to carry channeled information at high-speeds is preferred in many instances to carrying channeled information at other electromagnetic wavelengths/frequencies in media such as microwave transmission lines, coaxial cable lines and twisted-pair transmission lines. Advantages of optical media include higher channeled capacities (bandwidth), a greater immunity to electromagnetic interference, and a lower propagation loss. In fact, it is common for high-speed optical signals to have signal rates in the range of approximately several megabites per second (Mbits/sec) to approximately several tens of gigabites per second (Gbits/sec), and greater. However, while particularly advantageous in effecting high signal rates, optical subassemblies have proven difficult to produce in mass production at acceptable yield levels.

Such electro-optical systems have typically included more than one active element that are to be in optical communication with one another. The orientations required for effective optical coupling typically result in vertical stacking arrangements, individual submounts for each active element, and/or use of reflective surfaces. What is needed is a technique for fabricating optical subassemblies in an automated manner without sacrificing performance that result from inaccuracies of conventional automated processing techniques.

### SUMMARY OF THE INVENTION

The present invention relates to an optical subassembly and its method of manufacture which overcomes at least one of the above disadvantages.

Advantageously, the present invention provides a reduction in cost due to the elimination of extra parts, the accurate location of parts on the assembly, and the heat dissipation of the emitter, which is required for suitable operation.

According to an exemplary embodiment of the present invention, a handling vehicle becomes part of final product, and allows for the elimination of separate submounts for certain devices, such as an emitter and a detector. In particular, the devices are provided on the same submount at an angle to one another, allowing both integration and effective optical coupling.

At least one of the above and other objects may be realized by providing an optical subassembly including a first active optical element having a first plane for optical coupling, a second active optical element having a second plane for optical coupling, wherein when the first active optical element and the second active optical element are oriented to optically couple, the first plane and the second plane are substantially not parallel, and a submount on which the first and second active optical elements are mounted, the submount having a principal surface, one of the first and second active elements being mounted on the principal surface of the submount and another of the first and second active optical elements being mounted on the submount at an angle from the principal surface, thereby allowing optical coupling between the first and second active optical elements.

The optical subassembly may be part of an electro-optical package including a circuit board on which the submount is mounted and direct electrical connections between the first and second active optical elements and the circuit board.

At least one of the above and other objects may be realized by providing a method of forming an optical subassembly including providing a first active optical element having a first plane for optical coupling on a submount, providing a second active optical element having a second plane for optical coupling on the submount, wherein when the first active optical element and the second active optical element are oriented for optical coupling, the first plane and the second plane are substantially not parallel, mounting one of the first and second active elements on a principal surface of the submount, and mounting another of the first and second optical elements on the submount at an angle from the principal surface, thereby allowing optical coupling between the first and second active elements.

The submount may be part of an array of submounts and a first active element for at least two submounts in the array of submounts are simultaneously provided. The method may further include separating the array of submounts into individual submounts to thereby form the optical subassembly. The method may further include simultaneously testing at least two active elements in the array of submounts. The providing of the first and second active optical elements may include mounting both the first and second active optical elements on the principal surface of the submount and bending a portion of the submount containing one of the first and second active elements to allow optical coupling between the first and second active optical elements.

These and other objects of the present invention will become more readily apparent from the detailed description given hereinafter. However, it should be understood that the detailed description and specific examples, while indicating the preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The invention is best understood from the following detailed description when read with the accompanying drawing figures. It is emphasized that the various features are not necessarily drawn to scale. In fact, the dimensions may be arbitrarily increased or decreased for clarity of discussion.

FIG. 1 is top-view of an optical subassembly on a circuit board according to an illustrative embodiment of the present invention.

FIG. 2 is a cross-sectional view of an optical subassembly according to an illustrative embodiment of the present invention.

FIG. 3 is a top-view of a lead frame according to an illustrative embodiment of the present invention.

FIG. 3A is a top view of the detail A in FIG. 3.

FIG. 4 is a top detailed view of another configuration of the lead frame.

### DETAILED DESCRIPTION

In the following detailed description, for purposes of explanation and not limitation, exemplary embodiments disclosing specific details are set forth in order to provide a thorough understanding of the present invention. However, it will be apparent to one having ordinary skill in the art having had the benefit of the present disclosure, that the present invention may be practiced in other embodiments that depart from the specific details disclosed herein. Moreover, descriptions of well-known devices, methods and materials may be omitted so as to not obscure the description of the present invention.

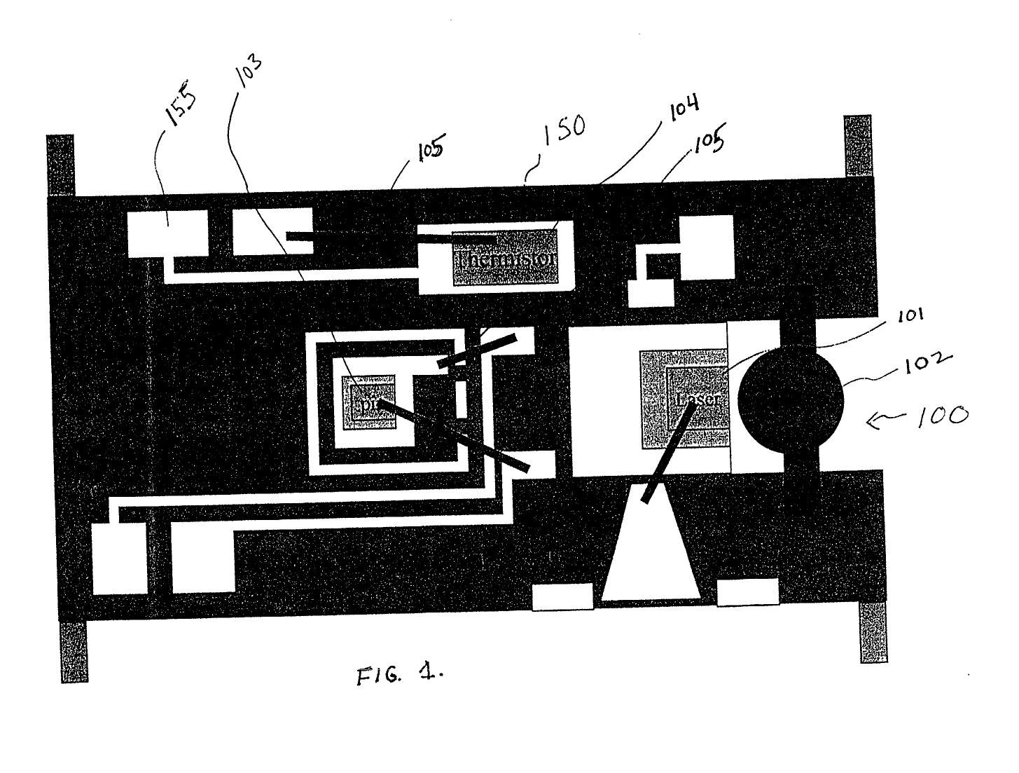

Turning to FIG. 1, a top-view of an optical subassembly 100 mounted on a circuit board 150 is shown. The optical subassembly 100 includes an emitter 101, e.g., a laser or a light emitting diode (LED), in optical communication with a passive optical device 102, illustratively a lens element. The optical subassembly 100 also includes a photodetector 103. The photodetector 103 is illustratively a surface detector such as a PIN photodetector. Of course, this is illustrative, and other photodetectors may be used. Moreover, a thermistor 104 may be used to monitor the operating temperature of the laser 101. As shown in FIG. 1, various wire or ribbon bonds 105 are used to make certain electrical connections from the optical subassembly 100 to the circuit board 150, while metal traces 155 on the circuit board 150 are also used for this purpose.

The emitter 101 shown in FIG. 1 emits radiation from two planes, a front facet and a rear facet. The front facet of the emitter 101 typically emits much more radiation than the rear facet and the radiation emitted from the front facet is output to a desired application. The radiation emitted from the rear facet may be output to the photodetector 103 to monitor the power of the radiation output by the emitter 101. This information, in conjunction with information regarding temperature provided by the thermistor 104, if present, may be used to control the operation of the emitter 101 in a known manner.

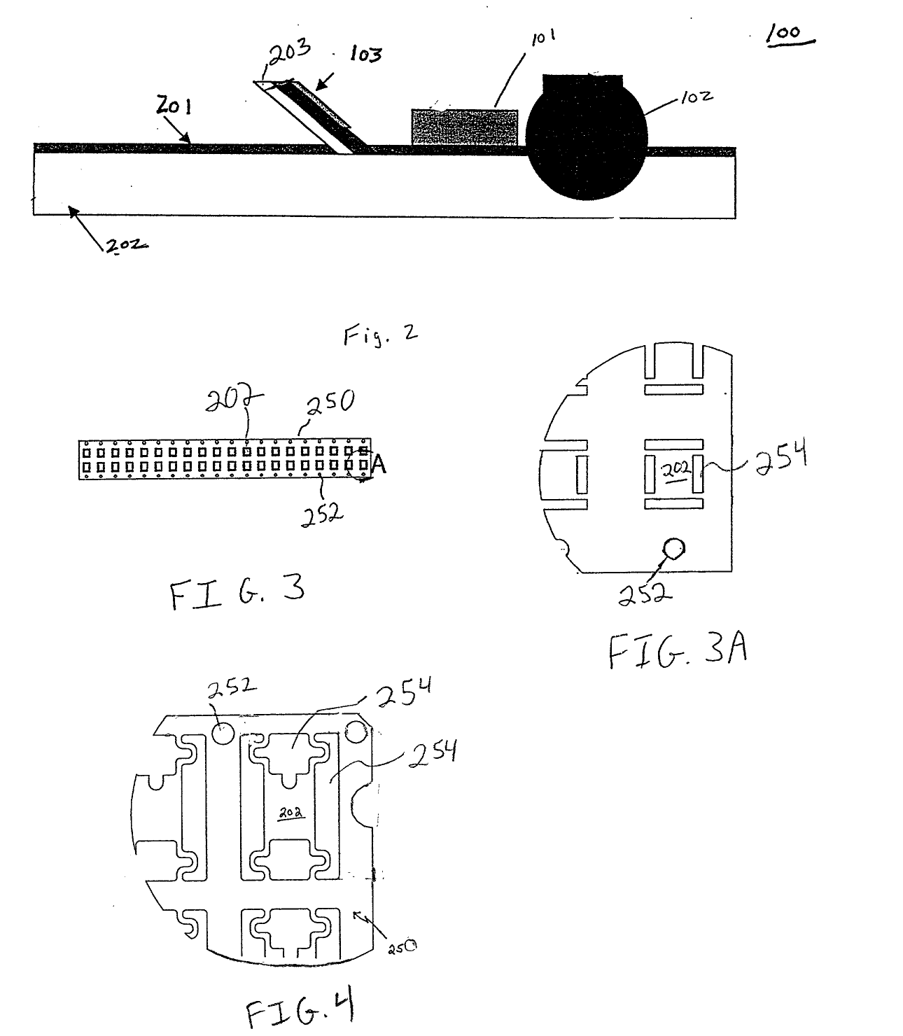

Turning to FIG. 2, a cross-sectional view of the optical subassembly 100 according to an illustrative embodiment of the present invention is shown. Illustratively, a substrate 202 is an electrical lead frame assembly or any substrate material, such as Kovar, providing heat sinking for the active elements. A top layer 201 may be disposed over the substrate 202, and is illustratively an oxide material. As shown in FIG. 2, the optical element 102 may be inserted into a v-groove or other feature in the substrate 202. The optical element 102 is aligned to couple the light from the front facet of the emitter 101 to an end use. The optical element 102 could be a ball lens, a tube with a first optic and isolator or a beam splitter for front facet monitoring, or any number of drop-in optical elements. The photodetector 103 is mounted on an angled portion or tab 203 of the substrate 202. The photodetector is aligned to receive light from a rear facet of the emitter 101 to monitor the power of the emitter 101. This allows for the elimination of separate submounts for the emitter 101 and the photodetector 103. A thermistor, which not seen in this view, may be included in the optical subassembly 100.

The assembly of the optical subassembly 100 may be done in planar form, i.e., the emitter 101 bonded to the lead frame 202, the monitor 103 bonded to the lead frame, then the wire/ribbon bonding performed. After the planar structure is completed, the monitor 103 would be bent into position to receive light from the rear facet.

According to one advantageous aspect of the present invention, as shown in FIG. 3, automated processing of a plurality of optical subassemblies 100 may be facilitated by simultaneously populating a mount 250. As shown in FIG. 3, and as seen in more detail in FIG. 3A, the mount 250 includes a plurality of substrates 202 to be separated after population thereof to form the optical subassemblies 100 and alignment holes 252 to facilitate to automated processing of the mount 250. As shown in FIG. 3, the mount 250 is a lead frame, containing a plurality of substrates 202. Attachment of the substrate 202 to the mount 250 may be performed in a conventional manner, i.e., the substrate 202 may be thermo-compression bonded, soldered or epoxied to the lead frame 250. Attachment points 254 may be designed to minimize heat conduction from the substrate 202 to the lead frame 250 itself. Another configuration of attachment points 254 is shown in FIG. 4. The attachment points 254 allow temperature testing or curing of epoxy on a single device site because it allows a single location to be cycled in temperature without affecting the other devices. These spaces between the optical substrates 202 on the mount 250 allow for thermal expansion and contraction without distorting the mount 250. To this end, the mount 250 containing a plurality of substrates 202 may be used as a handling vehicle is part of the final optical subassembly 100 or the optical subassembly 100 may be completely removed from the mount 250.

The use of the mount 250 in this manner allows for various cost advantages in the elimination of extra parts, the accurate location of parts on substrate 202 and the provision of a heat sink necessary for proper operation of the active devices, particularly the emitter 101. Also, direct testing of devices may be carried out on the mount 250 before the mount 250 is separated into respective optical subassemblies 100.

The mount 250 also enables the proper positioning of the photodetector 103 through relatively straightforward manipulation of the mount 250 during automated processing. When using lead frames as mounts, these lead frames have holes or slots along the side that allows the frame to be moved from position to position as it travels through a piece of equipment. After the planar configuration is completed, the photodetector 103 is bent into position as noted above. Rather than bending, the detector 103 could be mounted on a molded part 203, although this adds parts to the assembly and makes the planer assembly more difficult. The coating 201 may be patterned during deposition so that when the tab containing the detector 103 is bent up to form 203, there would be no material to crack. Since continuity of this coating 201 is not critical to the design, patterning a gap where the tab needs to bend is viable approach to solving this concern.

The angled portion 203 may be adjusted to capture light from the rear facet of the emitter 101. This could be an active process if the coupling to the back monitor needed to be precisely controlled. In most cases, an angle would be determined through experimentation or through computer modeling and the detector 103 would be mechanically bent to the desired angle after completing the assembly. This angle will depend on the far-field angle for the emitter 101 and could be anywhere from 0° to ˜ 140°. As such, increased monitor currents, depending on the asymmetry of the laser chip and the distances involved, may be achieved, allowing for more accurate monitoring of the device.

There are many ways to use extra parts to get light coupled from the emitter 101 to the detector 103. For example, reflective parts mounted above or directly behind the bent portion 203 to direct more light into the detector 103, although this adds parts and thus increases cost and assembly requirements. Detectors 103 could be mounted to blocks at 90° to the emitter 101, although again this would require more parts and handling plus it is often very difficult to provide electrical connection for such a configuration. Additionally, the photodetector 103 could be is directly behind the laser to provide planar coupling, although this provides limited coupling for low power lasers and can result in signal to noise issues with the very low powers detected.

The subassembly 100, according to the exemplary embodiments shown in FIGS. 1 and 2, have certain clear advantages over conventional optical subassemblies. For example, when active elements have been processed on lead frames by conventional methods, the lead frames are then used to provide electrical connection from the active devices to other devices. According to an illustrative embodiment of the present disclosure, the optical subassembly 100, 200 is separated from or sheared from the supporting frame, and thereafter mounted directly onto a circuit board or package body. To this end, the structure shown in FIG. 2 would be ready for direct mounting onto a circuit board or package body, as shown in FIG. 1. Further, both active elements are provided on the same submount. This enables subassembly test and characterization in mass or by individual site without need for costly packaging. It also allows for migration to plastic and over-molded packages as well.

It will be obvious that the invention may be varied in a plurality of ways. For example, the optical subassemblies may include more than one detector-emitter pair. Such variations are not to be regarded as a departure from the scope of the invention. All such modifications as would be obvious to one skilled in the art are intended to be included within the scope of the appended claims.

What is claimed is:

1. An optical subassembly comprising:
a first active optical element having a first plane for optical coupling;
a second active optical element having a second plane for optical coupling, wherein when the first active optical element and the second active optical element are oriented to optically couple, the first plane and the second plane are substantially not parallel; and
a submount on which said first and second active optical elements are mounted, the submount having a principal surface, one of the first and second active elements being mounted on the principal surface of the submount and another of the first and second active optical elements being mounted on the submount at an angle from the principal surface, thereby allowing optical coupling between said first and second active optical elements.

2. The optical subassembly of claim 1, wherein one of said first and second active optical elements has a third plane for optical coupling.

3. The optical subassembly of claim 2, wherein an active optical element having the third plane for optical coupling optically couples to another optical element.

4. The optical subassembly of claim 3, wherein said another optical element is a passive optical element.

5. The optical subassembly of claim 4, wherein said passive optical element is a lens.

6. The optical subassembly of claim 3, wherein said another optical element is mounted on the submount.

7. The optical subassembly of claim 1, wherein the submount includes a portion thereof bent upward in a principal plane of the submount.

8. The optical subassembly of claim 1, wherein the submount is coated with oxide.

9. The optical subassembly of claim 1, wherein the first active element is an emitter and the second active element is a detector.

10. The optical subassembly of claim 9, wherein the detector is a monitor photodiode for the emitter.

11. The optical subassembly of claim 1, further comprising a temperature detector on the submount.

12. The optical subassembly of claim 1, wherein the submount acts as a heat sink for the active elements.

13. An electro-optical package comprising:
an optical subassembly comprising
a first active optical element having a first plane for optical coupling;
a second active optical element having a second plane for optical coupling, wherein when the first active optical element and the second active optical element are oriented for optical coupling, the first plane and the second plane are substantially not parallel, and
a submount on which said first and second active optical elements are mounted, the submount having a principal surface, one of the first and second active optical elements being mounted on the principal surface of the submount and another of the first and second active optical elements being mounted on the submount at an angle from the principal surface, thereby allowing optical coupling between the first and second active optical elements;
a circuit board on which the submount is mounted; and
direct electrical connections between the first and second active optical elements and the circuit board.

14. The package of claim 13, wherein the direct electrical connections include wire bonds between the first and second active elements and the circuit board.

15. The package of claim 13, wherein the optical subassembly further comprises a temperature detector bonded to the circuit board.

16. The package of claim 13, wherein the submount serves as a heat sink for the active elements.

17. A method of forming an optical subassembly comprising:
providing a first active optical element having a first plane for optical coupling on a submount;
providing a second active optical element having a second plane for optical coupling on the submount, wherein when the first active optical element and the second active optical element are oriented for optical coupling, the first plane and the second plane are substantially not parallel;
mounting one of the first and second active elements on a principal surface of the submount; and
mounting another of the first and second optical elements on the submount at an angle from the principal surface, thereby allowing optical coupling between the first and second active elements.

18. The method of claim 17, wherein the submount is part of an array of submounts and a first active element for at least two submounts in the array of submounts are simultaneously provided.

19. The method of claim 18, further comprising separating the array of submounts into individual submounts to thereby form the optical subassembly.

20. The method of claim 18, further comprising simultaneously testing at least two active elements in the array of submounts.

21. The method of claim 17, wherein said providing of the first and second active optical elements includes mounting both said first and second active optical elements on the principal surface of the submount and bending a portion of the submount containing one of the first and second active elements to allow optical coupling between the first and second active optical elements.
